(19) United States
(12) Patent Application Publication
(10) Pub. No.: US 2007/0223896 A1
(43) Pub. Date: Sep. 27, 2007

(54) Method for assembly of three-phase heater

(76) Inventors: Scott H. Bents, River Falls, WI (US); Eric C. Branwall, Shakopee, MN (US); J. Evan Johnson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/703,543

(22) Filed: Feb. 6, 2007

Related U.S. Application Data
(60) Provisional application No. 60/771,005, filed on Feb. 6, 2006.

(51) Int. Cl. H05B 3/58

(52) U.S. Cl. 392/472

(57) ABSTRACT

A method for assembling a three-phase AC heater is disclosed. The method features swaging individual legs of a three-phase heater within a tubing, then bundling the legs together in a lineal fashion for swaging within an outer tube. The ends of the heater assembly are fitted with potting cups and potted with a compound appropriate for resisting moisture and humidity.

### FIELD OF THE INVENTION

The present invention is directed to the field of electrical resistance heaters. Specifically, the disclosed invention is directed to methods for assembly of compact three-phase electrical heaters

### BACKGROUND

Cold temperatures are routinely encountered in high altitude operation. High altitude aircraft and satellites often require localized heating of certain components to assure proper operation when the component is in service. Electrical resistance heaters are a preferred means for delivering the localized heating because they can run off existing on-board power sources, such as 240 VAC three phase generators. Moreover, it is desirable that the local heating elements and any ancillary equipment be compact and light weight.

### SUMMARY OF THE INVENTION

A method for assembling a three-phase electrical resistance heater is disclosed. The heater assembly is of compact construction for operation in compact spaces. The heater assembly is configured for operation directly from on-board three-phase power sources, thereby negating the need for electrical transformers and rectifiers and their attendant weight.

The method features individual legs of a three-phase heater combined in a lineal fashion within an outer tube. The outer tube with individual legs are swaged resulting in a compact design with a pie-shaped cross-section with the walls of each segment spaced 120 degrees. The individual legs are spaced and terminated in a potting cup providing stress relief and moisture and humidity control.

### BRIEF DESCRIPTION OF THE DRAWINGS

FIG. 1 is a flow chart of the method for assembly of the heater according to an embodiment of the present invention;

FIG. 2 illustrates a potting cup assembly according to an embodiment of the present invention;

FIG. 3 is another view of the potting cup assembly of FIG. 2;

FIG. 4a illustrates heater sub-assembly in an embodiment of the invention;

FIG. 4b illustrates a termination of a heater subassembly according to an embodiment of the invention;

FIG. 5a illustrates a partially assembled heater assembly according to an embodiment of the present invention; and

FIG. 5b illustrates a heater assembly with a portion broken away according to an embodiment of the present invention; and

FIG. 6 shows the detail of the locating bushing in an embodiment of the present invention.

FIG. 7 is a cross-sectional view taken at line 7-7 of FIG. 5b; and

FIG. 8 is a cross-sectional view taken at line 8-8 of FIG. 5b.

### DETAILED DESCRIPTION OF THE INVENTION

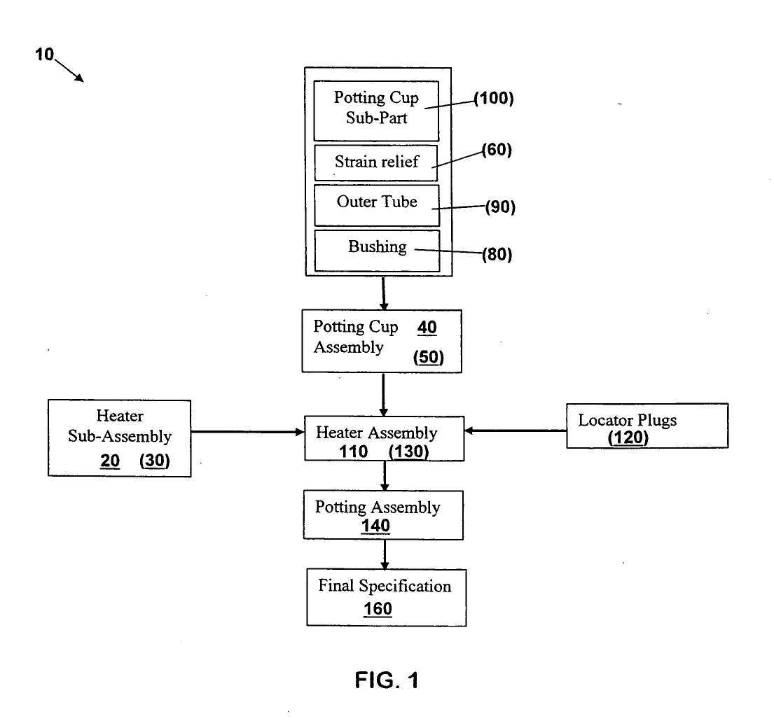

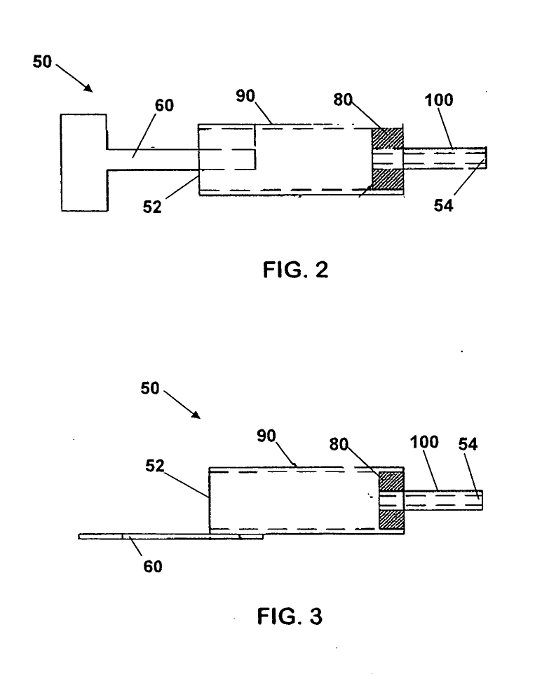

Referring to FIG. 1, a flow chart 10 depicts a series of steps for a method of assembly according to an embodiment of the present invention. Numerical reference numerals for the physical configurations and components used in the various steps are identified in parentheses. A heater sub-assembly method 20 produces a heater sub-assembly 30. A potting cup assembly method 40 produces a potting cup assembly 50. Referring to FIGS. 1 through 3, the potting cup assembly 50 produced by the potting cup assembly method 40 has a strain relief 60, a bushing 80, an outer tube 90, and a potting cup sub-part 100. The outer tube 90 and the potting cup sub-part 100 may be joined to the bushing by silver brazing. The potting cup assembly 50 has two ends: a large diameter end 52, and a small diameter end 54.

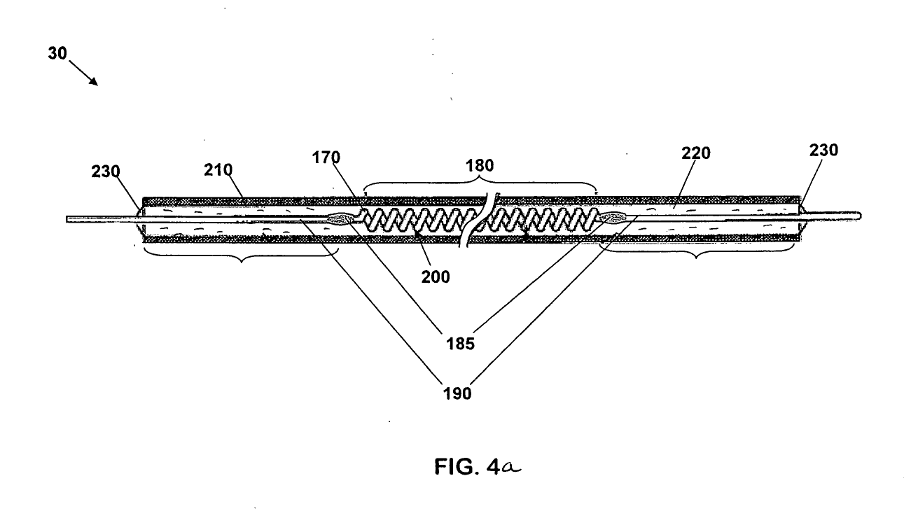

A heater assembly method 110 utilizes three heater units or sub-assemblies 30, the potting cup assemblies 50, and locator plugs 120 to produce a heater assembly 130. A potting assembly method 140 is performed on the heater assembly 130, followed by a final inspection 160 for compliance with specifications. Referring to FIG. 4, the heater sub-assembly 30 is a resistive wire configured as a heater coil 200, such as nickel chromium wire, supported within compacted refractory material 220 that insulates the coil from the outer casing 210. The refractory material may be magnesium oxide. Lead wires 210 are brazed or otherwise attached to the heater coil 200. The outer casing can be nickel. The capped ends 230 are sealed such as by melted glass.

Referring to FIG. 4b, a metal ceramic hermetic termination 280 is brazed to the casing. The lead wire 190 is brazed to the cap 240 at the ceramic metal termination as is the insulated exterior lead wire.

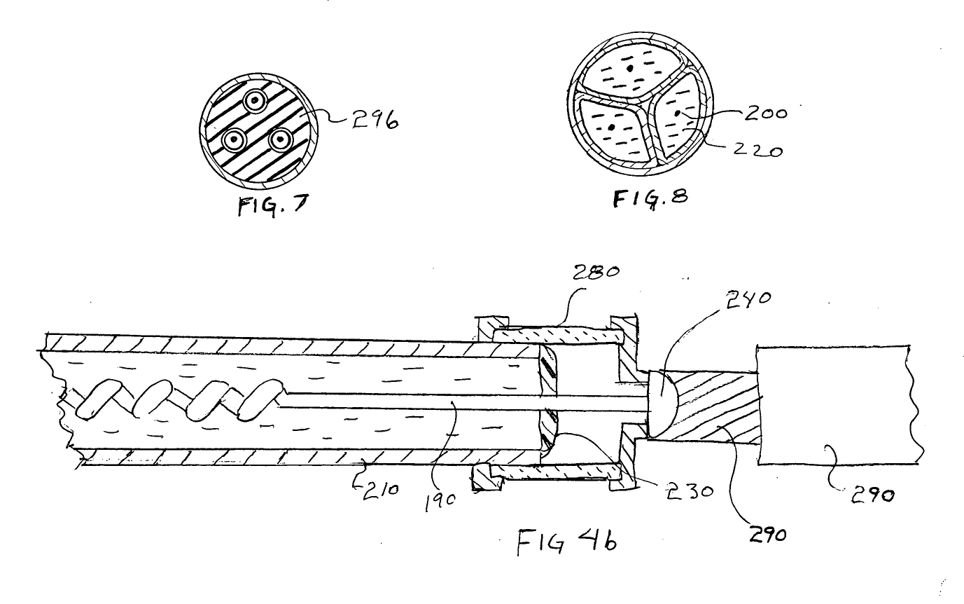

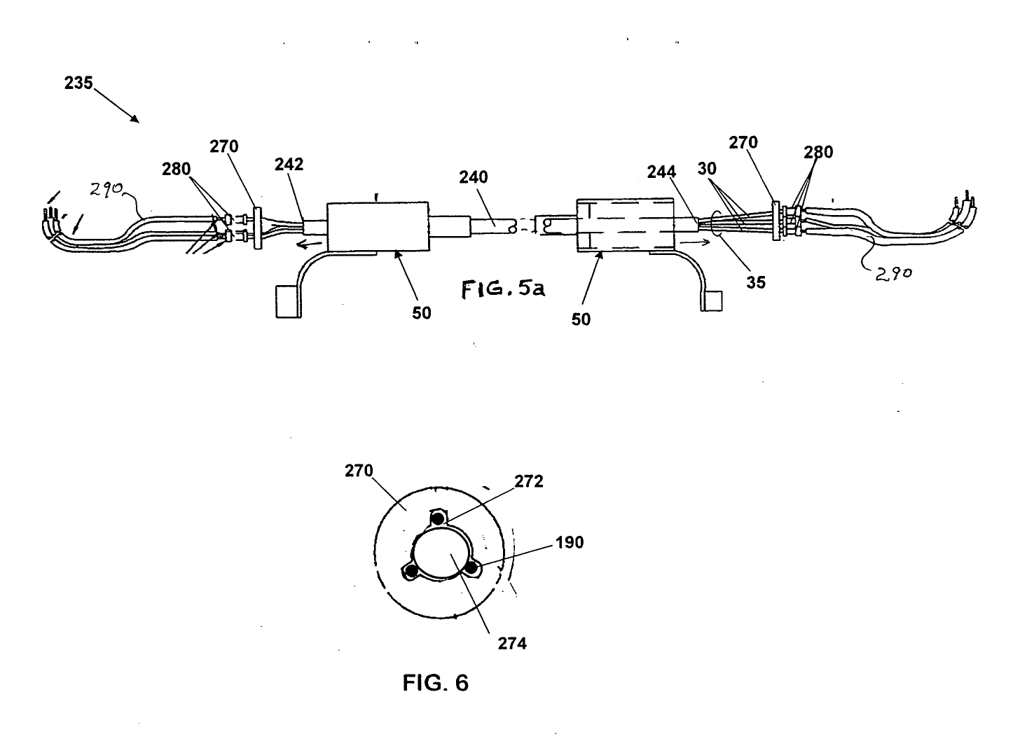

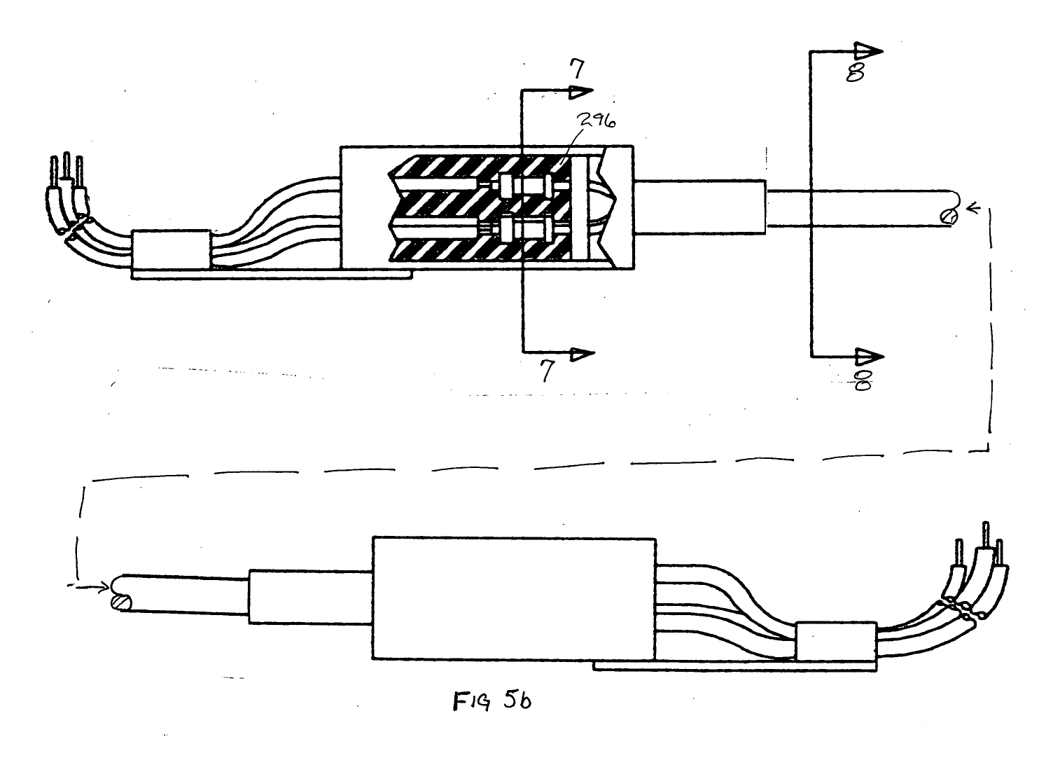

Referring to FIG. 5, a heater assembly 235 is illustrated. The heater assembly 235 is constructed using the heater assembly method 110 as described below:
1. Obtain three (3) heater sub-assemblies 30 and straighten them.
2. Obtain a length of outer tubing 240. The tubing may be made of nickel.
3. Group the three heater sub-assemblies 30 in a lineal bundle 35 and align them on one end. Feed the bundled sub-assemblies 30 into one end 242 of the outer tubing 240 and push the sub-assemblies 30 through the outer tubing 240 until the leads 190 emerge out the other end 244 of the outer tubing 240. Align each 4-in. lead mark on the emerging lead 190 so that it is even with the end 244 of the outer tubing 240.
4. Insert end 242 inside a swaging tool (not shown) and swage the outer tubing 240 to a specified diameter.
5. Swage the outer tubing 240 over the length of the lineal bundle 35.
6. Trim the outer tubing 240 on each end to assure a cold section 250 is on each end, and that the cold sections 250 are of approximately equal length.
7. Measure the end-to-end length of outer tubing 240. This length should be between 51-in. and 53-in.
8. Anneal the outer tubing 240 containing the heater sub-assemblies 30.
9. Oven bake the outer tubing 240 containing the heater sub-assemblies 30.
10. Test electrical isolation between the heater coil assembly 200 and the outer tubing 240 with a high potential electrical tester (“Hypot”) at 800 volts. Confirm that leakage current between the heater coil assembly 200 and the outer tubing 240 is less than 0.05-mA.
11. For each end of the heater assembly 110, slide potting cup assembly 50 over the outer tubing 240 so that the lead 190 projects through the large diameter end 52. That is, when the potting cup assembly has been fed over the end of the outer tubing 240, the large diameter end faces the nearest lead end of the heater assembly 110.
12. For each end of the heater assembly 110, slide a terminal locating bushing 270 over the over the internal leads 190 so the internal leads 190 are in the grooves 272 of the bushing 270. Insert terminal locating plug 274 into center of bushing 270 to retain leads 190 in grooves 272.
13. Braze a ceramic metal termination 280 onto the end of each lead 190 with silver braze or by TIG welding.
14. Mark smaller diameter elements at 0.85-in. and at 1.0-in. from end of outer tubing 240. Position the ceramic metal termination 280 so that a 0.40-in. length of the leads 190 extend into the ceramic metal termination 280. This space allows for re-alignment of ceramic metal termination pieces without damage of the tubes 210.
11. Insert the locating plug 120 inside the terminal locating bushing 270.
12. Silver braze terminal locating bushing 280, leads 190 and locator plugs 120 at each end of heater assembly 110.
13. Braze on a specified length of external lead wires 290. The lead wires 290 may be of 18 gage MGT with silicone exterior (Duraflex 550S 5400), rated for 450° C. service.
14. Check resistance of the heater assembly 30 for compliance within specified parameters.
15. Fill the potting cups with suitable potting material 296.

Note the swaging of the three individual heater sub assemblies, creates the pie shaped cross-section shown in FIG. 8. The ends of the heater sub assemblies are terminated in the potting cup and embedded in suitable potting material 296. This provides a highly efficient reduced diameter heater that is extremely robust and suitable for aerospace or outer space applications.

It is noted that the same methods disclosed are not limited to the creation of the specific embodiments described herein. For example, the physical dimensions of the resultant assembly, (e.g. hot section length, cold section length, wire diameter, and the diameters of the various tubing) may vary according to specific requirements and still be within the scope of the present invention. Likewise, the heating elements may be of a straight or a coiled configuration, and may be comprised of any suitable resistive element. Also, the annealing temperatures may differ, depending on the materials being utilized, and still be within the scope of the claimed method. Other embodiments will also be obvious to skilled artisans who utilize the methods disclosed herein.

What is claimed is:

1. A method for manufacturing or assembling a three-phase heater comprising the steps of:
inserting three encased heater units in a parallel arrangement within an elongate metallic tubing, each encased heater unit having a heater coil encased in refractory material in a metallic tube, two ends and an internal lead wire extending from each end, the ends of the tube sealed;
swaging the tube and the three encased heater units as substantially described herein.

2. The method of claim 1, further comprising the step of attaching external lead wires to each of the internal leads at three respective terminations.

3. The method of claim 2, further comprising the step of positioning the three respective terminations in a potting cup and adding potting material to said potting cup.

4. A three phase heater comprising three elongate heater units encased in a elongate tubular sheath, each of the three encased heater units positioned in a parallel arrangement, each encased heater unit having a heater coil encased in refractory material in a metallic tube, two ends and an internal lead wire extending from each end, the ends of each tube sealed; the cross-section of the three heater units in the tubular sheath being a pie shape with walls of the three heater units positioned at 120 degrees with respect to one another.
